(19) United States
(12) Patent Application Publication
(10) Pub. No.: US 2025/0289697 A1
(43) Pub. Date: Sep. 18, 2025

(54) Powered Tent Stake Pulling Device

(71) Applicant: Preston Smidt, Jacksonville, FL (US)

(72) Inventor: Preston Smidt, Jacksonville, FL (US)

(21) Appl. No.: 18/602,876

(22) Filed: Mar. 12, 2024

(51) Int. Cl. B66F 19/00

(52) U.S. Cl. CPC B66F 19/00

(57) ABSTRACT

A powered tent stake pulling device includes a base structure, a first tube, a second tube, an engagement structure, a drive arrangement, an adapter arrangement, and a tool support frame. The powered tent stake pulling device is designed to be used with a handheld rotary power tool. The first tube and the second tube have a telescoping design. The engagement structure is attached to a lower end of the second tube and designed to engage and grip a tent stake to be pulled from the ground. When the handheld rotary power tool is activated, the adapter arrangement transfers torque forces to the drive arrangement, which raises the second tube and the engagement structure to extract the tent stake from the ground quickly and easily. The powered tent stake pulling device is portable to permit a user to move from one tent stake to another and extract them.

### CROSS-REFERENCE TO RELATED APPLICATIONS Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tent stake pulling devices and more particularly pertains to a new powered tent stake pulling device for quickly and easily pulling multiple tent stakes using a handheld rotary power tool as the power source.

### (2) Description of Related Art Including Information Disclosed Under 37 CFR 1.97 and 1.98

The prior art relates to tent stake pulling devices. The prior art, as best understood, discloses either manual tent stake pulling devices powered by the strength of the user or very complex powered tent stake pulling devices that very expensive, large, and generally difficult to use. The prior art does not disclose a powered tent stake pulling device for quickly and easily pulling multiple tent stakes using a handheld rotary power tool as the power source.

### BRIEF SUMMARY OF THE INVENTION

An embodiment of the disclosure meets the needs presented above in a powered tent stake pulling device generally comprising a base structure, a first tube, a second tube, an engagement structure, a drive arrangement, an adapter arrangement, and a tool support frame. The powered tent stake pulling device is designed to be used with and to incorporate a handheld rotary power tool, such as a right-angle drill or a right-angle impact driver, though other drills and rotary power tools could be used. The base structure is designed to be positioned flat on a ground surface adjacent a tent stake to be pulled from the ground. The first tube is detachably connected to the base structure and designed to extend transversely from the base structure. The second tube is positioned about the first tube in a telescoping manner such that the second tube may be moved axially back and forth with respect to the first tube. The engagement structure is attached to a lower end of the second tube and designed to engage and grip a tent stake to be pulled from the ground. The drive arrangement is positioned in the first tube and the second tube and is actuatable to raise and lower the second tube. The adapter arrangement is designed to be engaged by a handheld rotary power tool and is connected to the drive arrangement to transfer rotary forces from a handheld rotary power tool to the drive arrangement to raise the second tube and the engagement structure attached thereto and extract a tent stake or similar object from the ground, and to lower the second tube prior to or after extraction of a tent stake from the ground. The tool support frame is attached to the adapter arrangement and designed to detachably connect to and support a handheld rotary power tool.

While the powered tent stake pulling device is primarily intended for use in removing stakes for commercial or large tents, it could be used for the removal of different elongated or rod-shaped structures that are at least partially buried in the ground and can be removed by pulling.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a powered tent stake pulling device according to an embodiment of the disclosure.

FIG. 2 is a rear view of an embodiment of the disclosure.

FIG. 3 is a front view of an embodiment of the disclosure.

FIG. 4 is a top view of an embodiment of the disclosure.

FIG. 5 is a side view of an embodiment of the disclosure in use.

FIG. 6 is a side view of an embodiment of the disclosure in use.

FIG. 7 is a close up view of an upper portion of an embodiment of the disclosure.

FIG. 8 is a close up exploded view of a lower portion of an embodiment of the disclosure.

FIG. 9 is a partial view of a portion of an embodiment of the disclosure.

FIG. 10 is an exploded view of a portion of an embodiment of the disclosure.

### DETAILED DESCRIPTION OF THE INVENTION

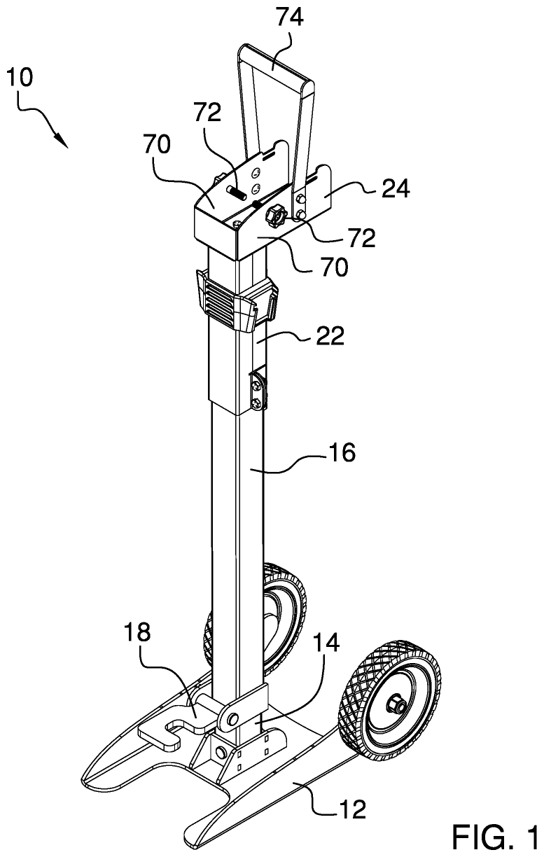

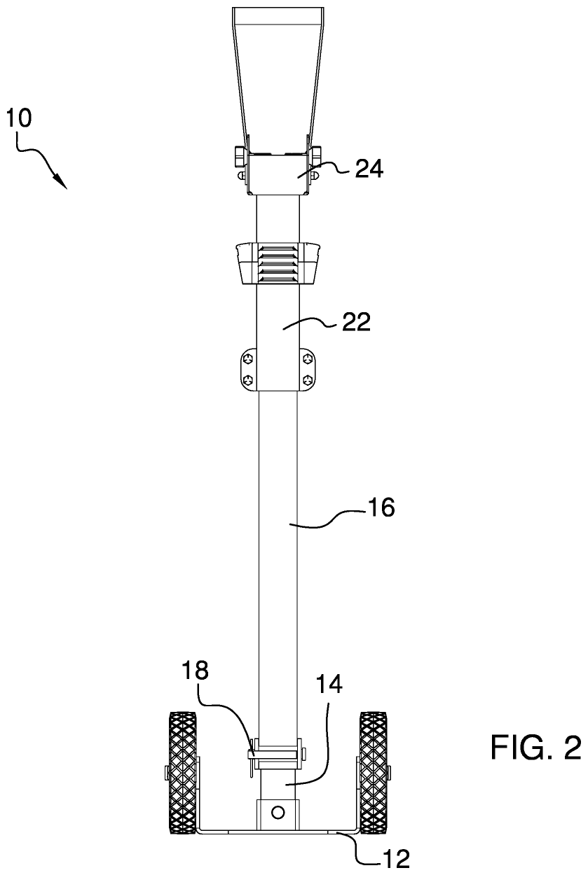

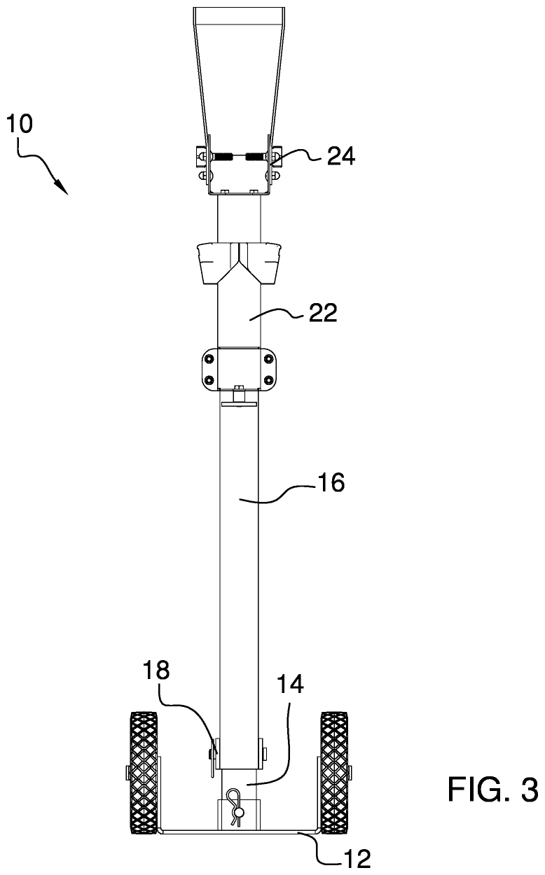

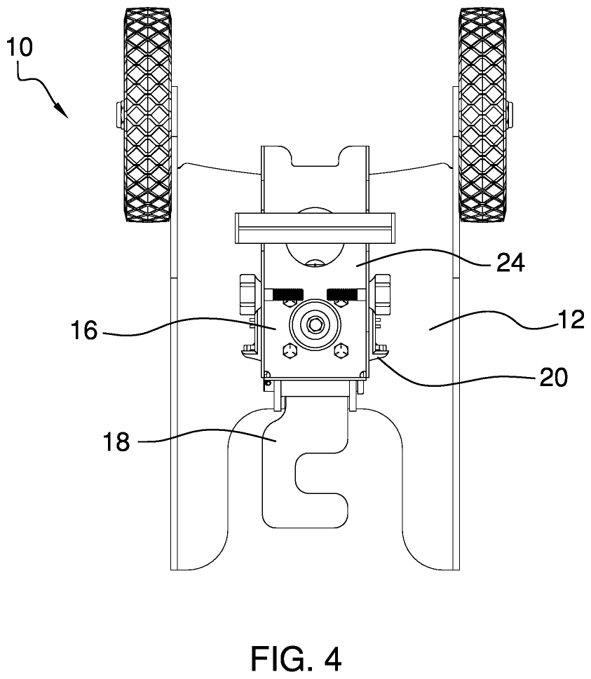

With reference now to the drawings, and in particular to FIGS. 1 through 10 thereof, a new powered tent stake pulling device embodying the principles and concepts of an embodiment of the disclosure and generally designated by the reference numeral 10 will be described.

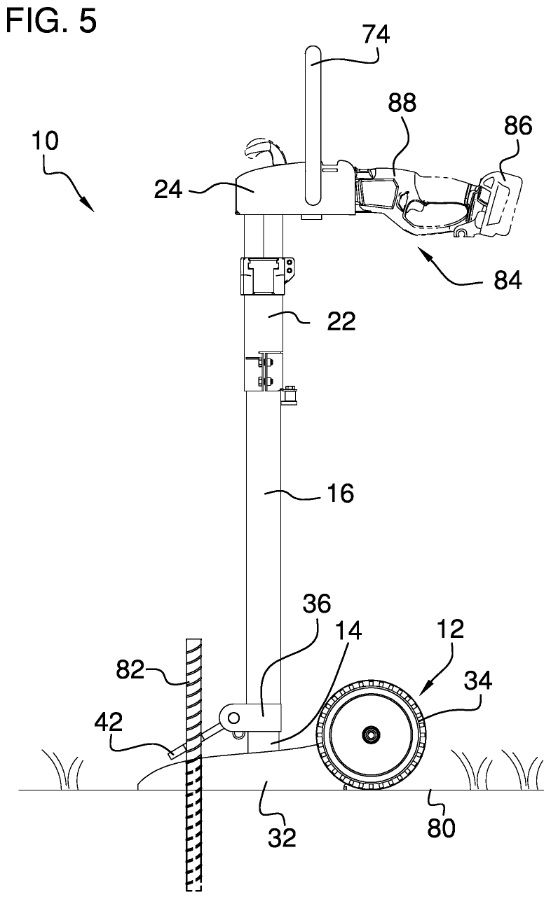

As best illustrated in FIGS. 1 through 10, the powered tent stake pulling device 10 generally comprises a base structure 12, a first tube 14, a second tube 16, an engagement structure 18, a drive arrangement 20, an adapter arrangement 22, and a tool support frame 24. FIGS. 1 through 4 show these basic components, which are shown in greater detail in the other figures. As best seen in FIGS. 5, 6, and 8, the base structure 12 is designed to be positioned flat on a ground surface 80 adjacent a tent stake 82 to be pulled from the ground. The base structure 12 includes a base plate 26. The base plate 26 includes a recess 28 and two plate extensions 30 designed to be placed around a tent stake 82 to be pulled from the ground. The recess 28 acts essentially like a centering guide so that the plate extensions 30 can provide maximum stability and support when a tent stake 82 is pulled from the ground. Two base flanges 32 are connected to and extend transverse from the base plate 26. Two wheels 34 are rotatably mounted on the two base flanges 32 and are designed to permit movement of the powered tent stake pulling device 10 by hand along a ground surface 80 from one location to another to permit easy removal of multiple stakes at different locations. The base plate 26 may be made of steel or similar material strong or durable material.

The first tube 14 is detachably connected to the base structure 12 and designed to extend transversely from the base structure 12. The second tube 16 is positioned about the first tube 14 in a telescoping manner such that the second tube 16 may be moved axially back and forth with respect to the first tube 14. Both the first tube 14 and the second tube 16 may be made of steel or similar strong or durable material.

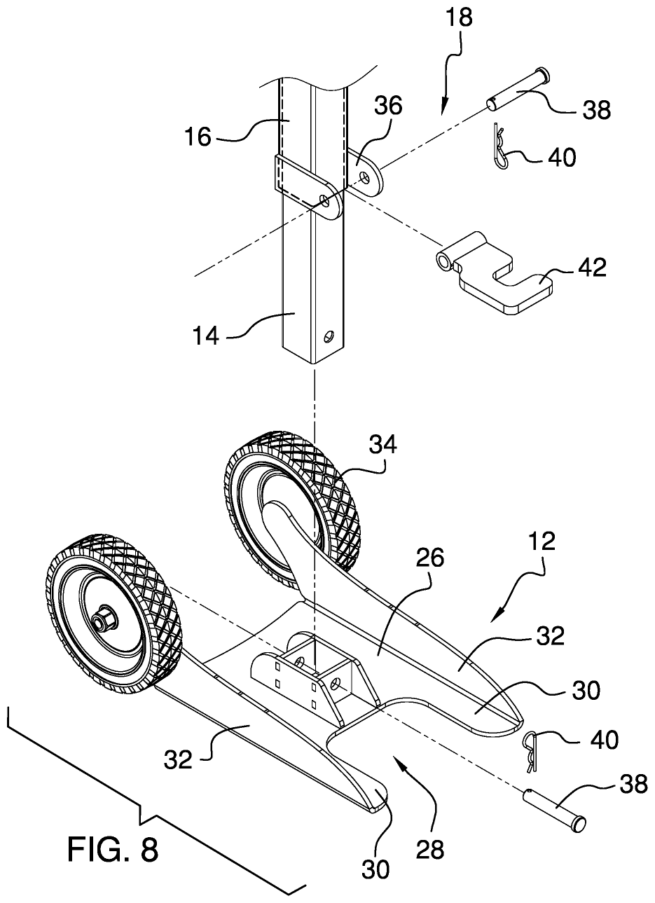

As seen in FIG. 8, the engagement structure 18 is attached to a lower end of the second tube 16 and designed to engage and grip a tent stake 82 to be pulled from the ground. The engagement structure 18 includes a mounting bracket 36 attached to the second tube 16 and a pin 38 that is detachably connected by a clip 40 and oriented horizontally in the mounting bracket 36. The engagement structure 18 includes a gripping head 42 that is substantially C-shaped and pivotably connected to the pin 38 to permit pivoting movement of the gripping head 42 about the pin 38. A similar pin 38 and clip 40 can be used to detachably connect the first tube 14 to the base plate 26. The gripping head 42 could be other shapes provided that there is an opening into which the shaft of the tent stake 82 may be placed.

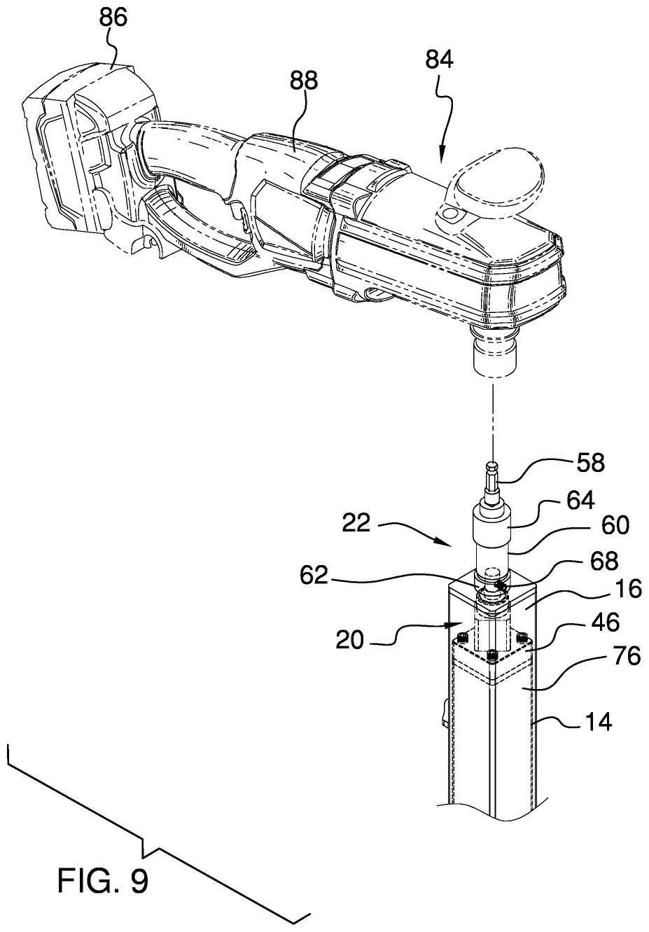

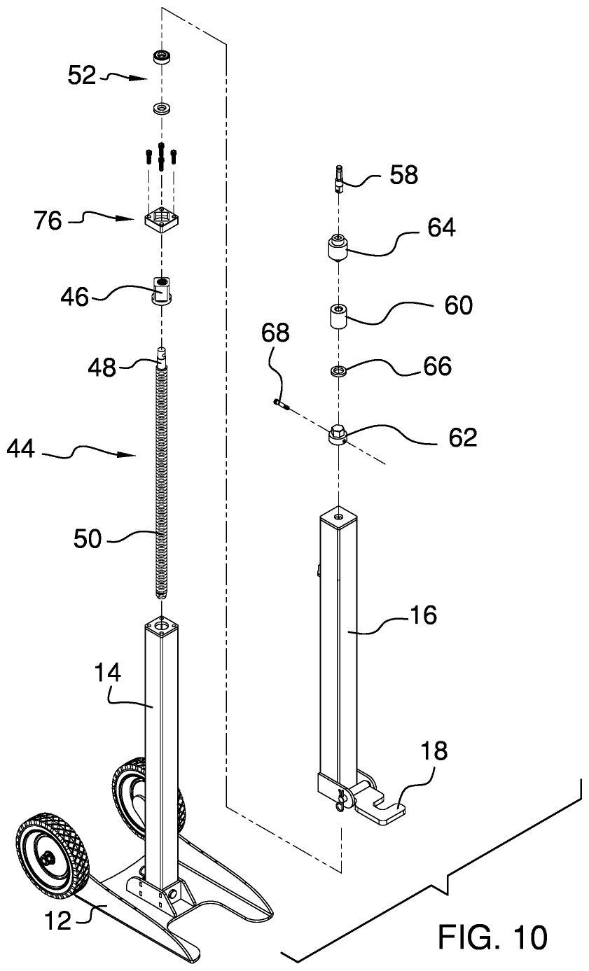

With reference to FIGS. 9 and 10, the drive arrangement 20 is positioned in the first tube 14 and the second tube 16 and is actuatable to raise and lower the second tube 16. As shown in FIG. 10, the drive arrangement 20 includes a threaded lifting rod 44 positioned within the first tube 14 and a lift nut 46 detachably connected to a top end of the first tube 14 by a retaining structure 76. The lift nut 46 can be a low-friction bronze nut. The threaded lifting rod 44 includes a connecting end portion 48 positioned to project out of the lift nut 46 and is operatively connected to the adapter arrangement 22. The threaded lifting rod 44 is designed to be rotated and axially moved into and out of the second tube 16 via the lift nut 46. The threaded lifting rod 44 is operatively connected to the second tube 16 such that upon axial movement of the threaded lifting rod 44 the second tube 16 is raised and lowered. The threaded lifting rod 44 includes a threaded body portion 50 having a greater diameter than the connecting end portion 48. The drive arrangement 20 includes a thrust bearing arrangement 52, such as a thrust ball bearing and support, positioned about the connecting end portion 48 and between the threaded body portion 50 and the second tube 16 to permit rotation of the threaded lifting rod 44 and transfer of axial lifting forces to the second tube 16. To further explain, as the threaded lifting rod 44 is rotated due to operation of the handheld rotary power tool 84, as will be discussed below, the threaded lifting rod 44 engages with the lift nut 46. Since the lift nut 46 is in a fixed position on the first tube 14, the threaded lifting rod 44 moves relative to the lift nut 46, thereby driving the second tube 16 back and forth. The thrust bearing arrangement 52 minimizes wear on the threaded lifting rod 44 and an inner contact surface of the second tube 16, especially during raising of the second tube 16 when pulling out a tent stake 82 when axial forces are very strong.

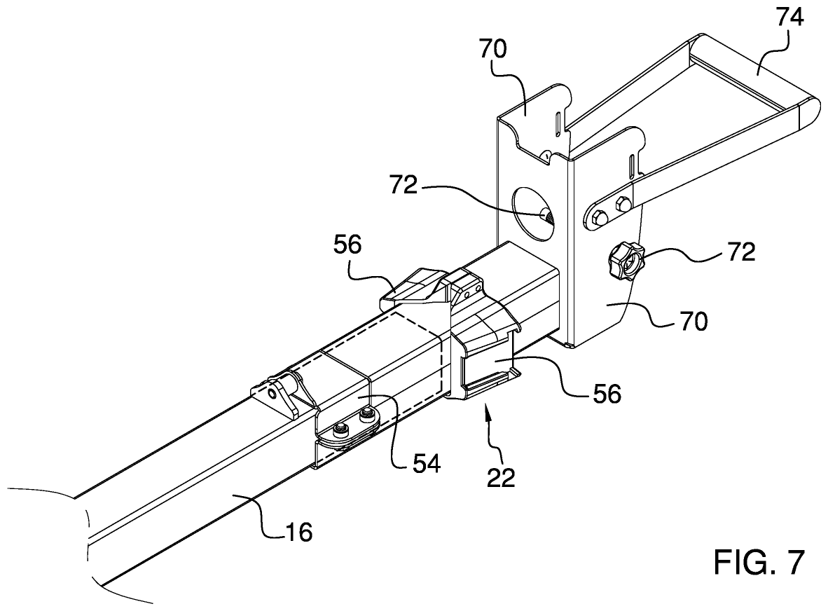

The adapter arrangement 22 is designed to be engaged by the handheld rotary power tool 84 and is connected to the drive arrangement 20 to transfer rotary forces from the handheld rotary power tool 84 to the drive arrangement 20. This transfer of forces raises the second tube 16 and the engagement structure 18 attached thereto to extract the tent stake 82, as well as lowers the second tube 16 prior to or after extraction of a tent stake 82. As seen in FIG. 7, the adapter arrangement 22 includes an adapter housing 54 attached to an upper end of the second tube 16. The adapter housing 54 is attached to the second tube 16 and designed to be moved with the second tube 16. The adapter housing 54 includes at least one storage device 56 designed to store rechargeable batteries of the handheld rotary power tool 84. This permits a user to store additional rechargeable batteries 86 on the powered tent stake pulling device 10 for easy replacement of a dead rechargeable battery 86 with a fresh one. In the embodiment shown in FIG. 7, there are two storage devices 56 for two rechargeable batteries.

As seen in FIGS. 9 and 10, the adapter arrangement 22 includes a drive adapter 58 positioned to project out of a top face of the adapter housing 54 and designed to be engaged by the handheld rotary power tool 84. The drive adapter 58 basically is gripped by the drive mechanism of the handheld rotary power tool 84 like a drill or socket driver. A drive socket 60 is operatively connected to the drive adapter 58. A socket adapter 62 is designed and positioned to operatively connect the drive socket 60 to the drive arrangement 20. In the embodiment shown, a torque limiter 64 is included, which is designed to interrupt the transfer of rotary forces upon torque forces exceeding a predetermined amount in order to minimize or prevent damage to the drive arrangement 20. A shock-absorbing structure 66, such as a rubber gasket or cushion, is designed to permit operation of the torque limiter 64. The socket adapter 62 includes a locking pin 68 designed to detachably connect the socket adapter 62 to the connecting end portion 48 of the threaded lifting rod 44. It should be noted that the design of the adapter arrangement 22 disclosed herein promotes very efficient transfer of torque from the handheld rotary power tool 84 to the threaded lifting rod 44 such that the tent stake 82 is subjected to a very strong lifting force for ease of extraction. However, it should be understood that variations of the exact components that provide similar efficient transfer of torque forces are within the scope of the disclosure.

As best seen in FIG. 1, the tool support frame 24 includes side walls 70 and a locking arrangement 72 designed to prevent rotational and vertical displacement of a body 88 of the handheld rotary power tool 84 upon activation thereof to maintain engagement with the adapter arrangement 22 and promote transfer of rotary forces to the adapter arrangement 22. In other words, when the handheld rotary power tool 84 is activated, the rotary forces could cause the body 88 to rotate, but the side walls 70 prevent that. The tool support frame 24 also includes a handle 74 designed to permit a user to tow the powered tent stake pulling device 10 by hand.

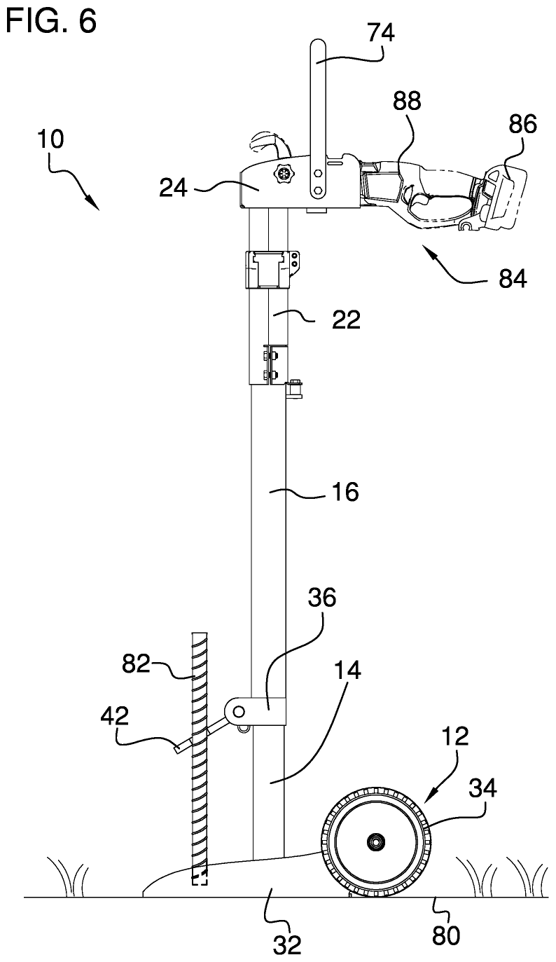

As best seen in FIGS. 5 and 6, in order to pull tent stakes 82 using the powered tent stake pulling device 10, the user first places the base structure 12 flat on a ground surface 80 adjacent the tent stake 82. The user then detachably connects the engagement structure 18 to a shaft of the tent stake 82 and grips the tent stake 82. The user then grasps and activates the handheld rotary power tool 84, which in turn engages the adapter arrangement 22 and transfers rotary forces from the handheld rotary power tool 84 to the drive arrangement 20. The threaded lifting rod 44 of the drive arrangement 20 is then rotated, causing the threaded lifting rod 44 to advance vertically out of the first tube 14 and thereby raise the second tube 16. The engagement structure 18 is therefore also lifted, which results in extraction of the tent stake 82 from the ground. Once extracted, the user can remove the tent stake 82 from the engagement structure 18. The user can then activate the handheld rotary power tool 84 to drive the threaded lifting rod 44 in the opposite direction, which results in the second tube 16 and the engagement structure 18. The user can now grasp the handle 74 and tilt the powered tent stake pulling device 10 onto the wheels 34. The user then can move the powered tent stake pulling device 10 by hand along a ground surface 80 to another tent stake 82 and repeat the preceding steps. In this manner, the user can very quickly and easily remove one stake after another until all tent stakes 82 have been extracted, which saves time and effort.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A powered tent stake pulling device comprising:
a base structure being configured to be disposed on a ground surface adjacent a tent stake to be pulled from the ground;
a first tube being detachably connected to said base structure and configured to extend transversely from said base structure;
a second tube being disposed about said first tube in a telescoping manner such that said second tube may be moved back and forth with respect to said first tube;
an engagement structure being disposed on said second tube and configured to engage and grip a tent stake to be pulled from the ground;
a drive arrangement being disposed in said first tube and said second tube and being actuatable to raise and lower said second tube;
an adapter arrangement being configured to be engaged by a handheld rotary power tool and being connected to said drive arrangement to transfer rotary forces from a handheld rotary power tool to said drive arrangement to raise said second tube and said engagement structure attached thereto and extract a tent stake or similar object from the ground, and to lower said second tube prior to or after extraction of a tent stake from the ground; and
a tool support frame connected to said adapter arrangement and configured to detachably connect to and support a handheld rotary power tool.

2. The powered tent stake pulling device of claim 1, wherein said base structure comprises:
a base plate;
said base plate comprises a recess and two plate extensions configured to be placed around a tent stake to be pulled from the ground;
two base flanges connected to and extending transverse from said base plate; and
two wheels rotatably mounted on said two base flanges and configured to permit movement of the powered tent stake pulling device by hand along a ground surface from one location to another to permit easy removal of multiple stakes at different locations.

3. The powered tent stake pulling device of claim 1, wherein said engagement structure comprises:
a mounting bracket attached to said second tube;
a pin detachably connected to and oriented horizontally in said mounting bracket; and
a gripping head being substantially C-shaped and pivotably connected to said pin to permit pivoting movement of said gripping head about said pin.

4. The powered tent stake pulling device of claim 1, wherein:
said drive arrangement comprises a threaded lifting rod disposed within said first tube and a lift nut detachably connected to a top end of said first tube by a retaining structure;
said threaded lifting rod comprises a connecting end portion disposed to project out of said lift nut and being operatively connected to said adapter arrangement;
said threaded lifting rod is configured to be rotated and axially moved into and out of said second tube via said lift nut; and
said threaded lifting rod is operatively connected to said second tube such that upon axial movement of said threaded lifting rod said second tube is raised and lowered.

5. The powered tent stake pulling device of claim 4, wherein:
said threaded lifting rod comprises a threaded body portion having a greater diameter than said connecting end portion; and
said drive arrangement comprises a thrust bearing arrangement disposed about said connecting end portion and between said threaded body portion and said second tube to permit rotation of said threaded lifting rod and transfer of axial lifting forces to said second tube.

6. The powered tent stake pulling device of claim 5, wherein said lift nut is a low-friction bronze nut.

7. The powered tent stake pulling device of claim 1, wherein said adapter arrangement comprises:
an adapter housing attached to an upper end of said second tube;
said adapter housing is attached to said second tube and configured to be moved with said second tube;
a drive adapter disposed to project out of a top face of said adapter housing and configured to be engaged by a handheld rotary power tool;
a drive socket operatively connected to said drive adapter;
a socket adapter configured and disposed to operatively connect said drive socket to said drive arrangement; and
said socket adapter comprises a locking pin configured to detachably connect said socket adapter to a threaded lifting rod.

8. The powered tent stake pulling device of claim 7, wherein said adapter arrangement further comprises:
a torque limiter configured to interrupt transfer of rotary forces upon torque forces exceeding a predetermined amount upon operation of a handheld rotary power tool to minimize or prevent damage to said drive arrangement; and
a shock-absorbing structure configured to permit operation of said torque limiter.

9. The powered tent stake pulling device of claim 8, wherein said adapter housing comprises at least one storage device configured to store rechargeable batteries of a handheld rotary power tool.

10. The powered tent stake pulling device of claim 1, wherein said tool support frame comprises side walls and a locking arrangement configured to prevent rotational and vertical displacement of a body of a handheld rotary power tool upon activation thereof to maintain engagement with said adapter arrangement and promote transfer of rotary forces to said adapter arrangement.

11. The powered tent stake pulling device of claim 10, wherein said tool support frame comprises a handle configured to permit a user to tow said powered tent stake pulling device by hand.

12. The powered tent stake pulling device of claim 5, wherein said adapter arrangement comprises:
an adapter housing attached to an upper end of said second tube;
said adapter housing is attached to said second tube and configured to be moved with said second tube;
a drive adapter disposed to project out of a top face of said adapter housing and configured to be engaged by a handheld rotary power tool;
a drive socket operatively connected to said drive adapter;
a socket adapter configured and disposed to operatively connect said drive socket to said drive arrangement; and
said socket adapter comprises a locking pin configured to detachably connect said socket adapter to a threaded lifting rod.

13. The powered tent stake pulling device of claim 12, wherein said adapter arrangement further comprises:
a torque limiter configured to interrupt transfer of rotary forces upon torque forces exceeding a predetermined amount upon operation of a handheld rotary power tool to minimize or prevent damage to said drive arrangement; and
a shock-absorbing structure configured to permit operation of said torque limiter.

14. The powered tent stake pulling device of claim 13, wherein said adapter housing comprises at least one storage device configured to store rechargeable batteries of a handheld rotary power tool.

15. The powered tent stake pulling device of claim 1, further comprising a handheld rotary power tool.

16. The powered tent stake pulling device of claim 15, wherein said handheld rotary power tool comprises one of: a right-angle drill and a right-angle impact driver, wherein the body of said handheld rotary power tool is oriented essentially radially and essentially perpendicular to said second tube to permit a user to rest a hand thereon.

17. A method of pulling tent stakes using a powered tent stake pulling device according to claim 15, said method comprising:
placing said base structure on a ground surface adjacent a tent stake to be pulled from the ground;
detachably connecting said engagement structure to a shaft of said tent stake and gripping said tent stake;
activating said handheld rotary power tool;
engaging said adapter arrangement and transferring rotary forces from said handheld rotary power tool to said drive arrangement;
engaging said drive arrangement and raising said second tube and said engagement structure and extracting said tent stake from the ground;
removing said tent stake from said engagement structure;
activating said handheld rotary power tool;
engaging said adapter arrangement and transferring rotary forces from said handheld rotary power tool to said drive arrangement;
engaging said drive arrangement and lowering said second tube and said engagement structure; and
tilting said powered tent stake pulling device onto wheels on said base structure and moving said powered tent stake pulling device by hand along a ground surface to another tent stake and repeating the preceding steps.

18. A powered tent stake pulling device comprising:
a base structure being configured to be disposed flat on a ground surface adjacent a tent stake to be pulled from the ground; said base structure comprises a base plate; said base plate comprises a recess and two plate extensions configured to be placed around a tent stake to be pulled from the ground; two base flanges connected to and extending transverse from said base plate; and two wheels rotatably mounted on said two base flanges and configured to permit movement of the powered tent stake pulling device by hand along a ground surface from one location to another to permit easy removal of multiple stakes at different locations; said base plate comprises steel;
a first tube being detachably connected to said base structure and configured to extend transversely from said base structure; said first tube comprises steel;
a second tube being disposed about said first tube in a telescoping manner such that said second tube may be moved axially back and forth with respect to said first tube; said second tube comprises steel;
an engagement structure being attached to a lower end of said second tube and configured to engage and grip a tent stake to be pulled from the ground; wherein said engagement structure comprises a mounting bracket attached to said second tube, a pin being detachably connected to and oriented horizontally in said mounting bracket, and a gripping head being substantially C-shaped and pivotably connected to said pin to permit pivoting movement of said gripping head about said pin;
a drive arrangement being disposed in said first tube and said second tube and being actuatable to raise and lower said second tube; said drive arrangement comprises a threaded lifting rod disposed within said first tube and a lift nut detachably connected to a top end of said first tube by a retaining structure; said lift nut is a low-friction bronze nut; said threaded lifting rod comprises a connecting end portion disposed to project out of said lift nut and being operatively connected to said adapter arrangement; said threaded lifting rod is configured to be rotated and axially moved into and out of said second tube via said lift nut; said threaded lifting rod is operatively connected to said second tube such that upon axial movement of said threaded lifting rod said second tube is raised and lowered; said threaded lifting rod comprises a threaded body portion having a greater diameter than said connecting end portion; said drive arrangement comprises a thrust bearing arrangement disposed about said connecting end portion and between said threaded body portion and said second tube to permit rotation of said threaded lifting rod and transfer of axial lifting forces to said second tube;
an adapter arrangement being configured to be engaged by a handheld rotary power tool and being connected to said drive arrangement to transfer rotary forces from a handheld rotary power tool to said drive arrangement to raise said second tube and said engagement structure attached thereto and extract a tent stake or similar object from the ground, and to lower said second tube prior to or after extraction of a tent stake from the ground; said adapter arrangement comprises:
an adapter housing attached to an upper end of said second tube; said adapter housing is attached to said second tube and configured to be moved with said second tube; said adapter housing comprises at least one storage device configured to store rechargeable batteries of a handheld rotary power tool; a drive adapter disposed to project out of a top face of said adapter housing and configured to be engaged by a handheld rotary power tool; a drive socket operatively connected to said drive adapter; a socket adapter configured and disposed to operatively connect said drive socket to said drive arrangement; a torque limiter configured to interrupt transfer of rotary forces upon torque forces exceeding a predetermined amount upon operation of a handheld rotary power tool to minimize or prevent damage to said drive arrangement; and a shock-absorbing structure configured to permit operation of said torque limiter; said socket adapter comprises a locking pin configured to detachably connect said socket adapter to said connecting end portion of said threaded lifting rod;
a tool support frame attached to said adapter arrangement and configured to detachably connect to and support a handheld rotary power tool, wherein said tool support frame comprises side walls and a locking arrangement configured to prevent rotational and vertical displacement of a body of a handheld rotary power tool upon activation thereof to maintain engagement with said adapter arrangement and promote transfer of rotary forces to said adapter arrangement; said tool support frame comprises a handle configured to permit a user to tow said powered tent stake pulling device by hand; and
a handheld rotary power tool comprising one of: a right-angle drill and a right-angle impact driver.
